(19) United States
(12) Patent Application Publication
(10) Pub. No.: US 2026/0031567 A1
(43) Pub. Date: Jan. 29, 2026

(54) RELAY CONNECTOR

(71) Applicant: SUMITOMO WIRING SYSTEMS, LTD., Mie (JP)

(72) Inventor: Masashi UCHIDA, Mie (JP)

(21) Appl. No.: 19/272,191

(22) Filed: Jul. 17, 2025

(30) Foreign Application Priority Data
Jul. 25, 2024 (JP) 2024-119457

(51) Int. Cl. H01R 13/52; H01R 13/506; H01R 13/73

(52) U.S. Cl. CPC H01R 13/5216; H01R 13/506; H01R 13/5202; H01R 13/521; H01R 13/73; H01R 2201/26

(57) ABSTRACT

A relay connector includes a first housing for holding a plurality of terminals and a second housing to be assembled with the first housing along a first direction. The relay connector includes a potting material injected into a recess and a first sealing member provided between the first and second housings while being compressed in the first direction. The first housing includes a first body portion and a first engaging portion. The second housing includes a second body portion including a plurality of insertion holes, through which the plurality of terminals are individually passed, and a second engaging portion engageable with the first engaging portion. The first sealing member is formed to surround the plurality of terminals. The first and second engaging portions are provided outside the first sealing member.

### CROSS-REFERENCE TO RELATED APPLICATIONS

This application is based on and claims priority from Japanese Patent Application No. 2024-119457, filed on Jul. 25, 2024, with the Japan Patent Office, the disclosure of which is incorporated herein in its entirety by reference.

### TECHNICAL FIELD

The present disclosure relates to a relay connector.

### BACKGROUND

Conventionally, a relay connector mounted on a device case storing oil such as a transmission case is known as a connector for vehicle (see, for example, Japanese Patent Laid-open Publication No. 2013-157256). The relay connector is a connector for electrically connecting the inside and outside of the device case. In the relay connector of this type, an oil stop function is enhanced by a potting material to prevent the leakage of the oil or the like in the device case to the outside of the device case.

### SUMMARY

The potting material shrinks during curing. According to this shrinkage of the potting material, terminals in a part sealed by the potting material may be deformed. If the terminals are deformed, pitches of the terminals vary, thereby causing a problem of reducing connection reliability to a mating connector.

The present disclosure aims to provide a relay connector capable of suppressing a reduction in connection reliability caused by the deformation of terminals.

The present disclosure is directed to a relay connector with a plurality of electrically conductive terminals, a first housing for holding the plurality of terminals, the first housing including a recess, a second housing to be assembled with the first housing along a first direction, a potting material injected into the recess, and a first sealing member provided between the first and second housings while being compressed in the first direction, the first housing including a first body portion for holding the plurality of terminals, a tubular first connector fitting portion projecting in the first direction from a first end surface facing in the first direction, out of the first body portion, the recess recessed in the first direction from a second end surface facing in a first opposite direction opposite to the first direction, out of the first body portion, and a first engaging portion engageable with the second housing, the second housing including a second body portion including a plurality of insertion holes, the plurality of terminals being individually passed through the plurality of insertion holes, and a second engaging portion engageable with the first engaging portion, the first sealing member being formed to surround the plurality of terminals, and each of the first and second engaging portions being provided outside the first sealing member.

According to the relay connector of the present disclosure, an effect capable of suppressing a reduction in connection reliability caused by the deformation of the terminals is achieved.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a section showing a relay connector of one embodiment.

FIG. 2 is a perspective view showing the relay connector of the embodiment.

FIG. 3 is an exploded perspective view showing the relay connector of the embodiment.

FIG. 4 is an exploded perspective view of a first housing and a second housing of the embodiment when viewed from mutually different directions.

FIG. 5 is a section showing a first step in a manufacturing method of the relay connector of the embodiment.

FIG. 6 is a section showing a second step in the manufacturing method of the relay connector of the embodiment.

FIG. 7 is a section showing a third step in the manufacturing method of the relay connector of the embodiment.

FIG. 8 is a section showing a fourth step in the manufacturing method of the relay connector of the embodiment.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### Description of Embodiments of Present Disclosure

First, embodiments of the present disclosure are listed and described.

[1] The relay connector of the present disclosure is provided with a plurality of electrically conductive terminals, a first housing for holding the plurality of terminals, the first housing including a recess, a second housing to be assembled with the first housing along a first direction, a potting material injected into the recess, and a first sealing member provided between the first and second housings while being compressed in the first direction, the first housing including a first body portion for holding the plurality of terminals, a tubular first connector fitting portion projecting in the first direction from a first end surface facing in the first direction, out of the first body portion, the recess recessed in the first direction from a second end surface facing in a first opposite direction opposite to the first direction, out of the first body portion, and a first engaging portion engageable with the second housing, the second housing including a second body portion including a plurality of insertion holes, the plurality of terminals being individually passed through the plurality of insertion holes, and a second engaging portion engageable with the first engaging portion, the first sealing member being formed to surround the plurality of terminals, and each of the first and second engaging portions being provided outside the first sealing member.

According to this configuration, the second housing is assembled with the first housing along the first direction. In other words, the first and second housings are constituted by separate components. Thus, the second housing can be assembled with the first housing after the potting material is injected into the recess, e.g. after the plurality of terminals are deformed due to the curing of the potting material. At this time, the second housing includes the plurality of insertion holes, through which the plurality of terminals are individually passed. By inserting the plurality of terminals respectively into the plurality of these insertion holes, the deformation of the plurality of terminals can be corrected and pitches of the plurality of terminals can be corrected based on those of the plurality of insertion holes. By assembling the second housing with the first housing after the potting material is formed in this way, the pitches of the plurality of terminals can be corrected to be approximated to desired pitches. In this way, a reduction in connection reliability to a mating connector can be suitably suppressed.

Further, in the relay connector, the assembled state (united state) of the first and second housings is maintained by the engagement of the first engaging portion of the first housing and the second engaging portion of the second housing. However, in the assembled state, a gap may be formed between the first and second housings. Liquid such as water may intrude into between the inner peripheral surfaces of the insertion holes and the outer peripheral surfaces of the terminals through such a gap. As a countermeasure against this, in the above relay connector, the first sealing member for surrounding the plurality of terminals is provided inside the first and second engaging portions. This first sealing member is provided between the first and second housings while being compressed in the first direction. Sealing can be suitably provided between the first and second housings by such a first sealing member. In this way, the intrusion of liquid into a space inside the first sealing member can be suitably suppressed, for example, even if a gap is formed near an engaged part of the first and second engaging portions. As a result, the intrusion of the liquid into between the inner peripheral surfaces of the insertion holes and the outer peripheral surfaces of the terminals can be suitably suppressed.

[2] In [1] described above, the first engaging portion may include a deflectable and deformable deflection piece extending along the first direction and an engaging projection projecting in an intersecting direction intersecting the first direction from an end part in the first opposite direction of the deflection piece.

According to this configuration, the engaging projection of the first engaging portion and the second engaging portion can be suitably engaged by snap fitting utilizing the deflection and deformation of the deflection piece of the first engaging portion. The assembled state of the first and second housings can be suitably maintained by the engagement of the engaging projection of the first engaging portion and the second engaging portion.

[3] In [1] or [2] described above, the first body portion may include an accommodation recess recessed in the first direction from the second end surface of the first body portion, the accommodation recess may be formed to surround the recess, and the first sealing member may be accommodated in the accommodation recess.

According to this configuration, the first sealing member is accommodated into the accommodation recess recessed in the first direction from the second end surface facing in the first opposite direction, out of the first body portion. Thus, a movement of the first sealing member can be restricted by the inner wall surface of the accommodation recess. In this way, a position deviation of the first sealing member in a direction orthogonal to the first direction can be suitably suppressed.

[4] In [3] described above, the first body portion may include a first outer peripheral wall for surrounding the first sealing member and a cut portion formed by cutting the first outer peripheral wall, and the first engaging portion may be provided in the cut portion.

According to this configuration, the first sealing member is surrounded by the first outer peripheral wall. Thus, a movement of the first sealing member can be restricted by the first outer peripheral wall. In this way, a position deviation of the first sealing member can be suitably suppressed.

[5] In [4] described above, the second body portion may include a back wall having a third end surface facing the second end surface of the first body portion and a second outer peripheral wall projecting in the first direction from the back wall, the second outer peripheral wall may be formed to surround the first outer peripheral wall, the first sealing member may be held in close contact with the third end surface of the back wall and held in close contact with a bottom surface of the accommodation recess, and the second engaging portion may be an engaging hole formed to penetrate through the second outer peripheral wall in a thickness direction.

According to this configuration, the second engaging portion is formed to penetrate through the second outer peripheral wall formed to surround the first outer peripheral wall. The second engaging portion is engaged with the first engaging portion provided inside the cut portion formed by cutting the first outer peripheral wall. A gap is easily formed between the first and second housings near the engaged part of these first and second engaging portions. As a countermeasure against this, in the above relay connector, the first sealing member is provided inside the first and second engaging portions. Sealing can be suitably provided between the first and second housings by such a first sealing member. In this way, the intrusion of liquid into a space inside the first sealing member can be suitably suppressed even if a gap is formed near the engaged part of the first and second engaging portions.

[6] In any one of [1] to [5] described above, the relay connector may be mounted into a mounting hole of a device case having an internal space and an external space, the internal space being an oil environment, the external space being an air environment, the second housing may include a second connector fitting portion projecting in the first opposite direction from a fourth end surface facing in the first opposite direction, out of the second body portion, the first connector fitting portion may be provided to project into the internal space of the device case, the second connector fitting portion may be provided to project into the external space of the device case, and an engaged part of the first and second engaging portions may be provided in the external space of the device case.

According to this configuration, the engaged part of the first and second engaging portions is provided in the external space of the device case, which is the air environment. Thus, it can be suitably suppressed that the engaged part of the first and second engaging portions, i.e. a part where a gap is easily formed between the first and second housings, is exposed to the oil environment.

[7] In [6] described above, the second body portion may include a fixing portion extending along a second direction intersecting the first direction, the fixing portion fixing the relay connector to the device case, the fixing portion may include a bolt hole, and the second body portion may be integrally formed with the second connector fitting portion.

According to this configuration, the relay connector can be fixed to the device case by tightening a bolt inserted into the bolt hole of the fixing portion. Further, the second body portion including the fixing portion for fixing the relay connector to the device case can be integrally formed with the second connector fixing portion. In this way, the number of components of the relay connector can be reduced as compared to the case where the second body portion including the fixing portion and the second connector fixing portion are constituted by separate components.

[8] In any one of [1] to [7] described above, the relay connector may be provided with a second sealing member mounted on an outer periphery of the first connector fitting portion and a retainer mounted on the outer periphery of the first connector fitting portion, and the retainer may be engageable with the second sealing member and restrict a movement of the second sealing member in the first direction.

According to this configuration, a movement in the first direction of the second sealing member mounted on the outer periphery of the first connector fixing portion is restricted by the retainer mounted on the outer periphery of the first connector fixing portion. In this way, the detachment of the second sealing member from the first connector fixing portion can be suitably suppressed.

### Details of Embodiment of Present Disclosure

A specific example of a relay connector of the present disclosure is described below with reference to the drawings. For the convenience of description, some components may be shown in an exaggerated or simplified manner in each drawing. Further, a dimension ratio of each part may be different in each figure. Further, “orthogonal” and “parallel” in this specification mean not only strictly orthogonal and parallel, but also substantially orthogonal and parallel within a range in which functions and effects in this embodiment are achieved. “Facing each other” in this specification indicates that surfaces or members are at positions in front of each other, and means not only a case where the surfaces or members are at positions perfectly in front of each other, but also a case where the surfaces or members are at positions partially in front of each other. “Facing each other” in this specification means not only a case where two members are separated from each other, but also a case where the two members are in contact with each other. A term “tubular” used in the description of this specification indicates not only a shape formed by a peripheral wall continuous over an entire periphery in a circumferential direction, but also a tubular shape formed by combining a plurality of components and a shape having a cut or the like in a circumferential part such as a C shape or a U shape. Note that “tubular” shapes include circular shapes, elliptical shapes and polygonal shapes with angular or round corners, but there is no limitation to these. Further, terms such as “first”, “second” and “third” in this specification are merely used to distinguish objects and do not rank the objects. A first axis X, a second axis Y orthogonal to the first axis X and a third axis Z orthogonal to both the first and second axes X, Y are shown in each figure. Further, a first direction X1, which is one direction along the first axis X, and a first opposite direction X2, which is another direction along the first axis X and a direction opposite to the first direction X1, are shown in each figure. A second direction Y1, which is one direction along the second axis Y, and a second opposite direction Y2, which is another direction along the second axis Y and a direction opposite to the second direction Y1, are shown in each figure. A third direction Z1, which is one direction along the third axis Z, and a third opposite direction Z2, which is another direction along the third axis Z and a direction opposite to the third direction Z1, are shown in each figure. Note that the present invention is not limited to these illustrations, but is represented by claims and intended to include all changes in the scope of claims and in the meaning and scope of equivalents.

### (Overall Configuration)

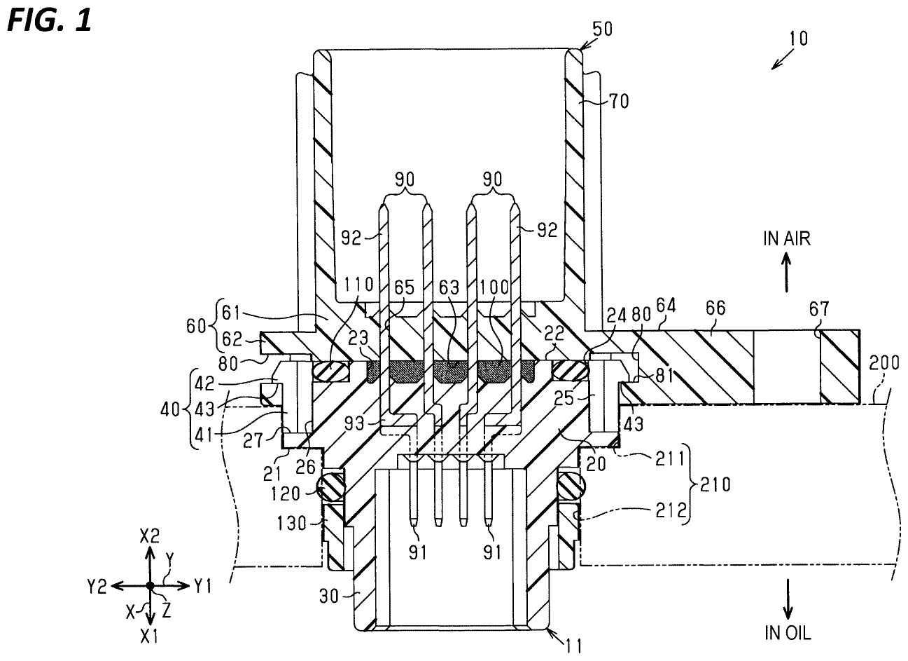

As shown in FIG. 1, a relay connector 10 is mounted on a device case 200 installed in a vehicle. The relay connector 10 is mountable on the device case 200 in an arbitrary orientation according to the posture of the device case 200. The relay connector 10 is fixed to the device case 200 by bolts or the like. The relay connector 10 is a connector for electrically connecting the inside and outside of the device case 200. Note that each direction in each figure does not necessarily represent the posture during the use of the relay connector 10.

The device case 200 is, for example, a transmission case. The device case 200 is, for example, made of metal. An internal space of the device case 200 is an oil environment, and an external space of the device case 200 is an air environment. An electric component such as a motor or a sensor is provided inside the device case 100. The device case 200 includes a mounting hole 210, through which the relay connector 10 is passed. The mounting hole 210 is formed to allow communication between the inside and outside of the device case 200.

The mounting hole 210 includes a first hole portion 211 and a second hole portion 212. The first hole portion 211 communicates with the second hole portion 212. The first hole portion 211 is provided in an end part in the first opposite direction X2 of the mounting hole 210. The planar size of the first hole portion 211 is larger than that of the second hole portion 212. The first hole portion 211 is formed into a circular shape concentric with the second hole portion 212.

The relay connector 10 is fit into the mounting hole 210 of the device case 200. The relay connector 10 is electrically connected to a first mating connector (not shown) provided in a control unit accommodating a control circuit and the like outside the device case 200. The relay connector 10 is electrically connected to a second mating connector (not shown) provided inside the device case 200 inside the device case 200. The control circuit provided in the control unit is electrically connected to the electric component provided inside the device case 200 via the first mating connector, the relay connector 10 and the second mating connector.

### (Configuration of Relay Connector 10)

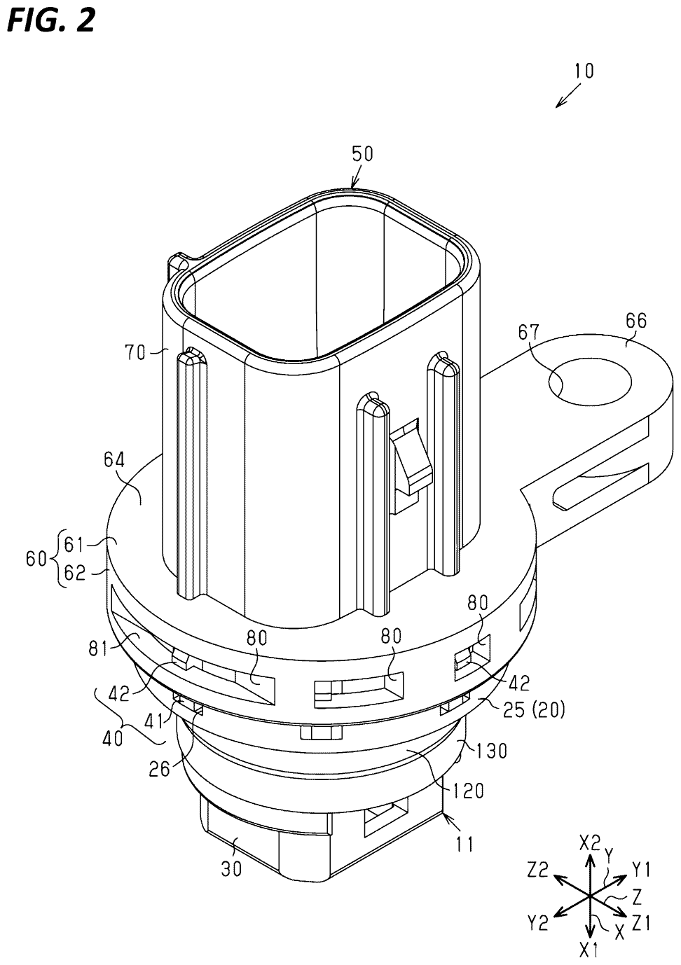

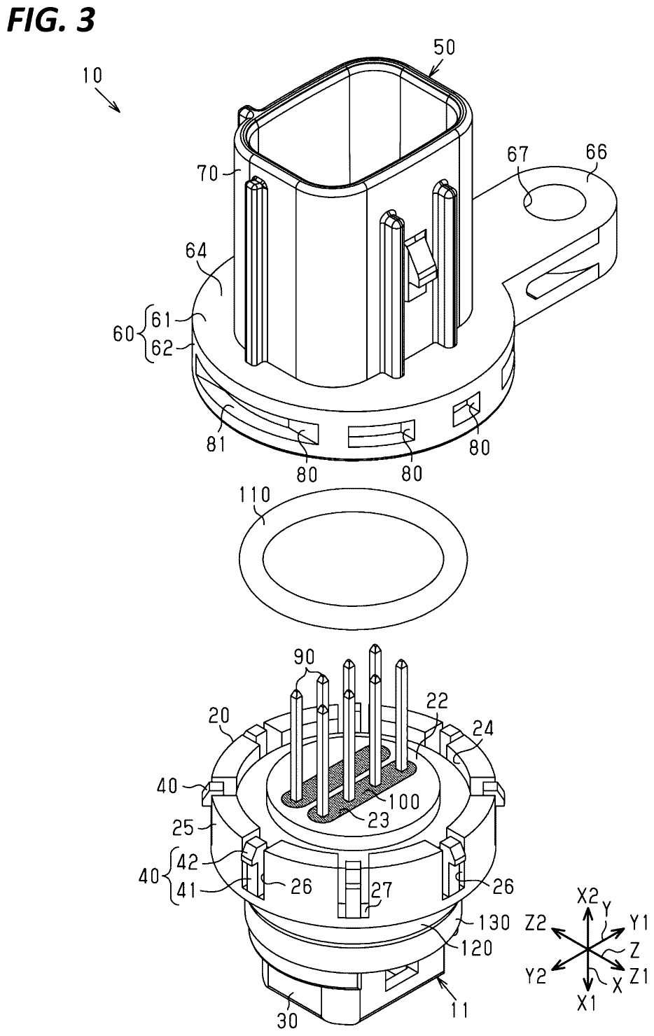

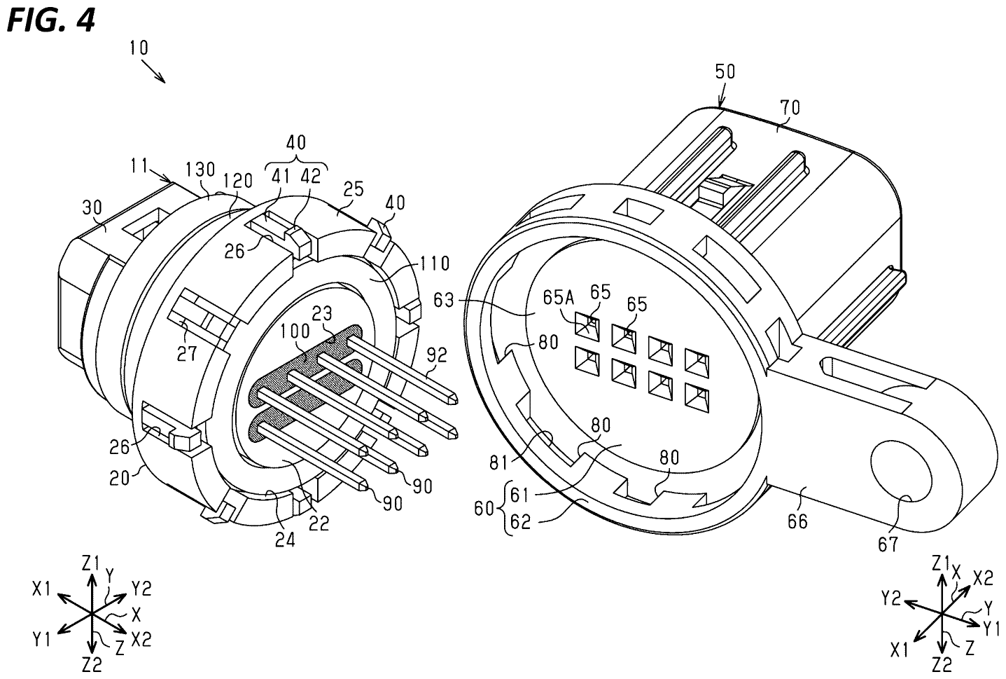

As shown in FIGS. 2 to 4, the relay connector 10 is provided with a first housing 11 and a second housing 50 assembled with the first housing 11. As shown in FIGS. 3 and 4, the relay connector 10 is provided with a plurality of (in this embodiment, eight) electrically conductive terminals 90 held in the first housing 11 and a potting material 100 for sealing the plurality of terminals 90. The relay connector 10 is provided with a first sealing member 110, a second sealing member 120 and a retainer 130.

### (Configuration of First Housing 11)

The first housing 11 is a component separate from the second housing 50. The first housing 11 is made of synthetic resin. The first housing 11 includes a first body portion 20, a tubular first connector fitting portion 30 and a plurality of first engaging portions 40. The first housing 11 is a single component integrally formed with the first body portion 20, the first connector fitting portion 30 and the first engaging portions 40.

### (Configuration of First Body Portion 20)

The first body portion 20 is formed into a disk shape as a whole. Here, in this specification, the “disk shape” indicates a disk shape having a circular planar shape and a predetermined thickness. Note that a ratio of the thickness to a diameter does not matter in the “disk shape”. Further, the “disk shapes” include those partially formed with recesses and protrusions.

As shown in FIG. 1, the first body portion 20 has a first end surface 21 and a second end surface 22. The first end surface 21 is an end surface facing the inside of the device case 200 and facing in the first direction X1. The second end surface 22 is an end surface provided opposite to the first end surface 21. The second end surface 22 is an end surface facing the second housing 50 and facing in the first opposite direction X2.

The first body portion 20 includes recesses 23 provided in the second end surface 22 and an accommodation recess 24 provided in the second end surface 22.

The recess 23 is formed to be recessed in the first direction X1 from the second end surface 22. As shown in FIG. 3, the recess 23 is provided in a central region of the second end surface 22. The first body portion 20 of this embodiment includes two recesses 23. Each recess 23 is formed to collectively surround a plurality of (in this embodiment, four) the terminals 90 in a plan view from the first direction X1. That is, four terminals 90 are accommodated inside one recess 23. Each recess 23 extends along the second axis Y. The two recesses 23 are provided side by side along the third axis Z.

The accommodation recess 24 is formed to be recessed in the first direction X1 from the second end surface 22. The accommodation recess 24 is formed to surround the two recesses 23 in a plan view from the first direction X1. The accommodation recess 24 is formed to surround a plurality of (in this embodiment, eight) the terminals 90 in the plan view from the first direction X1. The accommodation recess 24 of this embodiment is formed into a circular ring shape. The accommodation recess 24 is continuously formed over the entire periphery in a circumferential direction of the first body portion 20. The first sealing member 110 is accommodated in the accommodation recess 24.

The first body portion 20 includes a first outer peripheral wall 25 surrounding the accommodation recess 24 and a plurality of (in this embodiment, eight) cut portions 26 formed by cutting the first outer peripheral wall 25.

As shown in FIG. 4, the first outer peripheral wall 25 is formed to surround the first sealing member 110 accommodated in the accommodation recess 24. The first outer peripheral wall 25 constitutes the inner wall surface of the accommodation recess 24. The first outer peripheral wall 25 is formed over the entire periphery in the circumferential direction of the first body portion 20. As shown in FIG. 3, an end part in the first opposite direction X2 of the first outer peripheral wall 25 projects further in the first opposite direction X2 than the bottom surface of the accommodation recess 24.

The plurality of cut portions 26 are provided at intervals from each other in the circumferential direction of the first body portion 20. The plurality of cut portions 26 are provided at equal intervals in the circumferential direction of the first outer peripheral wall 25. Each cut portion 26 is formed by cutting the first outer peripheral wall 25 in the first direction X1 from the end part in the first opposite direction X2. Each cut portion 26 is open radially outwardly of the first body portion 20. Each cut portion 26 communicates with the accommodation recess 24. In particular, each cut portion 26 is formed to allow communication between the inside of the accommodation recess 24 and the outside of the first housing 11. Each cut portion 26 is formed to be recessed further in the first direction X1 than the bottom surface of the accommodation recess 24. In other words, a bottom surface 27 of each cut portion 26 is provided at a position further in the first direction X1 than the bottom surface of the accommodation recess 24.

As shown in FIG. 1, the first body portion 20 is inserted into the mounting hole 210 of the device case 200. The first body portion 20 is inserted into the inside of the mounting hole 210 along the first direction X1. The first body portion 20 is fit inside the first hole portion 211 of the mounting hole 210. The outer peripheral surface of the first body portion 20 is formed in conformity with the inner peripheral surface of the first hole portion 211. An end part in the first opposite direction X2 of the first body portion 20 projects further in the first opposite direction X2 than an end surface in the first opposite direction X2 of the device case 200.

The first body portion 20 holds the plurality of terminals 90. The first body portion 20 covers in close contact with the outer peripheral surface of each terminal 90 over the entire periphery in the circumferential direction. The first body portion 20 holds each terminal 90 with an intermediate part in axial direction embedded. In other words, a part of each terminal 90 is embedded inside the first housing 11. Each terminal 90 is, for example, integrally configured to the first housing 11 by insert molding.

### (Configuration of Terminals 90)

Here, each terminal 90 is made of metal. Each terminal 90 is in the form of a bar as a whole. As shown in FIG. 3, eight terminals 90 are provided at intervals along the second axis Y and along the third axis Z in a plan viewed from the first direction X1. The eight terminals 90 are arrayed in a lattice or in a matrix in the plan view from the first direction X1. The eight terminals 90 of this embodiment are arrayed in a 4×2 matrix.

As shown in FIG. 1, each terminal 90 includes a first terminal portion 91 projecting in the first direction X1 from the first end surface 21 of the first body portion 20 and a second terminal portion 92 projecting in the first opposite direction X2 from the bottom surface of the recess 23. Each terminal 90 includes a coupling portion 93 coupling the first and second terminal portions 91, 92.

Each first terminal portion 91 extends along the first axis X. Out of the eight first terminal portions 91, four first terminal portions 91 arranged along the second axis Y are arranged at first pitches along the second axis Y. Each second terminal portion 92 extends along the first axis X. Out of the eight second terminal portions 92, four second terminal portions 92 arranged along the second axis Y are arranged at second pitches along the second axis Y. Here, the second pitch is larger than the first pitch. Each coupling portion 93 includes a bent part for converting the pitch of each terminal 90 from the first pitch to the second pitch. Each coupling portion 93 is embedded in the first body portion 20.

### (Configuration of First Connector Fitting Portion 30)

The first connector fitting portion 30 projects in the first direction X1 from the first end surface 21 of the first body portion 20. The first connector fitting portion 30 projects into the internal space of the device case 200. The unillustrated second mating connector provided inside the device case 200 is fit into the first connector fitting portion 30.

The first connector fitting portion 30 is open in the first direction X1. The first connector fitting portion 30 surrounds the outer peripheries of the first terminal portions 91 of the terminals 90.

The annular second sealing member 120 is mounted on the outer peripheral surface of the first connector fitting portion 30. The second sealing member 120 is continuously formed over the entire periphery in the circumferential direction of the first connector fitting portion 30. When the first housing 11 is fit into the mounting hole 210, the second sealing member 120 is held in close contact with the inner peripheral surface of the mounting hole 210 over the entire periphery in the circumferential direction to seal between the outer peripheral surface of the first housing 11 and the inner peripheral surface of the device case 200. The second sealing member 120 is, for example, made of rubber.

The retainer 130 is mounted on the outer peripheral surface of the first connector fitting portion 30. The retainer 130 is mounted at a position further in the first direction X1 than the second sealing member 120. The retainer 130 is engageable with the second sealing member 120 along the first axis X. The retainer 130 restricts a movement of the second sealing member 120 in the first direction X1. The retainer 130 is, for example, made of synthetic resin.

### (Configuration of First Engaging Portions 40)

As shown in FIG. 3, the plurality of first engaging portions 40 are provided in the first body portion 20. The plurality of first engaging portions 40 are respectively provided in the plurality of cut portions 26. The plurality of first engaging portions 40 are provided at intervals from each other in the circumferential direction of the first body portion 20. The plurality of first engaging portions 40 are provided at equal intervals in the circumferential direction of the first body portion 20.

Each first engaging portion 40 includes a deflectable and deformable deflection piece 41 extending along the first direction X1 and an engaging projection 42 provided on an end part in the first opposite direction X2 of the deflection piece 41. The deflection piece 41 extends in the first opposite direction X2 from the bottom surface 27 of the cut portion 26. The deflection piece 41 is in the form of a cantilever with a base end part connected to the bottom surface 27 as a fixed end and a tip part on a side opposite to the base end part as a free end. The deflection piece 41 is configured to be deflectable in an intersecting direction (here, a radial direction of the first body portion 20) intersecting a length direction (here, the first direction X1) of the deflection piece 41. An end surface in the first opposite direction X2 of the deflection piece 41 is, for example, provided on the same plane as an end surface in the first opposite direction X2 of the first outer peripheral wall 25.

The engaging projection 42 projects in an intersecting direction (here, radially outwardly of the first body portion 20) intersecting the first direction X1 from a tip part of the deflection piece 41. As shown in FIG. 1, the engaging projection 42 has a first engaging surface 43. The first engaging surface 43 is formed to face in the first direction X1. The first engaging surface 43 is formed into a flat surface orthogonal to both the length direction of the deflection piece 41 and a projecting direction of the engaging projection 42. The first engaging surface 43 is formed in parallel to a YZ plane. The first engaging surface 43 is, for example, provided on the same plane as the bottom surface of the accommodation recess 24.

### (Configuration of Potting Material 100)

The potting material 100 is injected into the recesses 23. The potting material 100 is formed to fill the recesses 23. The potting material 100 is formed to surround each of the plurality of terminals 90. The potting material 100 is a sealing material for sealing insertion holes for the plurality of terminals 90. The potting material 100 covers in close contact with the outer peripheral surface of each terminal 90 over the entire periphery in the circumferential direction.

### (Configuration of Second Housing 50)

The second housing 50 is formed to be assemblable with the first housing 11 along the first direction X1. The second housing 50 is formed to be attachable to and detachable from the first housing 11. The second housing 50 is made of synthetic resin. The second housing 50 may be made of the same type of material as the first housing 11 or may be made of a material different from that of the first housing 11.

The second housing 50 includes a second body portion 60, a tubular second connector fitting portion 70 and a plurality of second engaging portions 80. The second housing 50 is a single component integrally formed with the second body portion 60, the second connector fitting portion 70 and the second engaging portions 80.

### (Configuration of Second Body Portion 60)

As shown in FIG. 4, the second body portion 60 is formed into a recess shape open in the first direction X1. The second body portion 60 includes a back wall 61 for closing an opening in the first opposite direction X2. The second body portion 60 includes a second outer peripheral wall 62 projecting in the first direction X1 from the outer peripheral edge of the back wall 61.

The back wall 61 is formed into a disk shape as a whole. As shown in FIG. 1, the back wall 61 has a third end surface 63 and a fourth end surface 64. The third end surface 63 is an end surface facing the first housing 11 and facing in the first direction X1. The third end surface 63 is formed into a flat surface parallel to a YZ plane. The fourth end surface 64 is an end surface provided opposite to the third end surface 63. The fourth end surface 64 is an end surface facing in the first opposite direction X2.

The second body portion 60 includes a plurality of (in this embodiment, eight) insertion holes 65, through which the plurality of (in this embodiment, eight) terminals 90 are individually passed. Each insertion hole 65 is formed to penetrate through the back wall 61 along the first axis X. As shown in FIG. 4, the eight insertion holes 65 are arrayed similarly to the eight terminals 90 in a plan view from the first opposite direction X2. The eight insertion holes 65 of this embodiment are arrayed in a 4×2 matrix in the plan view from the first opposite direction X2. Out of the eight insertion holes 65, four insertion holes 65 arranged along the second axis Y are arranged side by side at the second pitches along the second axis Y.

Each insertion hole 65 is formed such that the second terminal portion 92 of each terminal 90 can be passed therethrough. An inner diameter of each insertion hole 65 is slightly larger than an outer diameter of each second terminal portion 92. An end part in the first direction X1 of each insertion hole 65 is provided with a guiding surface 65A. The guiding surface 65A is formed to increase an opening width of the insertion hole 65 toward an opening end in the first direction X1 of the insertion hole 65. The guiding surface 65A has a function of smoothly guiding the second terminal portion 92 into the inside of the insertion hole 65 when the second terminal portion 92 of the terminal 90 is inserted into the insertion hole 65. Note that the guiding surfaces 65A are not shown to simplify the drawings in the sections such as FIG. 1. Although not shown, the potting material 100 is injected into each insertion hole 65. Each second terminal portion 92 projects further in the first opposite direction X2 than the bottom surface of the second connector fitting portion 70 while passing through each insertion hole 65.

As shown in FIG. 4, the second outer peripheral wall 62 projects in the first direction X1 from the third end surface 63 of the back wall 61. The second outer peripheral wall 62 is continuously formed over the entire periphery in the circumferential direction of the second body portion 60. As shown in FIG. 2, the second outer peripheral wall 62 is formed to surround the first outer peripheral wall 25 of the first housing 11. The end part in the first opposite direction X2 of the first body portion 20 is fit into an internal space of the second body portion 60, specifically a space surrounded by the back wall 61 and the second outer peripheral wall 62. As shown in FIG. 1, the second outer peripheral wall 62 is provided in the external space of the device case 200 when the first housing 11 is fit into the mounting hole 210.

The second body portion 60 includes a fixing portion 66 for fixing the relay connector 10 to the device case 200. The fixing portion 66 is formed to project in the second direction Y1 from the second outer peripheral wall 62. The fixing portion 66 is provided in the external space of the device case 200 when the first housing 11 is fit into the mounting hole 210. The fixing portion 66 projects in a direction orthogonal to an insertion direction (here, the first direction X1) of the first housing 11 into the mounting hole 210. An end surface in the first direction X1 of the fixing portion 66 is provided to be able to contact the outer surface of the device case 200. The fixing portion 66 is formed into a plate shape. The fixing portion 66 includes a bolt hole 67 penetrating through the fixing portion 66 along the first axis X. An unillustrated fixing bolt is inserted into the bolt hole 67. The second housing 50 is fixed to the device case 200 by tightening the bolt inserted into the bolt hole 67.

### (Configuration of Second Connector Fitting Portion 70)

The first connector fitting portion 70 projects in the first opposite direction X2 from the fourth end surface 64 of the back wall 61. The second connector fitting portion 70 projects into the external space of the device case 200. The unillustrated first mating connector provided outside the device case 200 is fit into the second connector fitting portion 70.

The second connector fitting portion 70 is open in the first opposite direction X2. The second connector fitting portion 70 surrounds the outer peripheries of the second terminal portions 92 projecting from the bottom surface of the second connector fitting portion 70.

### (Configuration of Second Engaging Portions 80)

As shown in FIG. 4, the plurality of second engaging portions 80 are provided in the second outer peripheral wall 62 of the second body portion 60. The plurality of second engaging portions 80 are provided to respectively correspond to the plurality of first engaging portions 40. The plurality of second engaging portions 80 are provided at intervals from each other in the circumferential direction of the second body portion 60.

Each second engaging portion 80 is formed to penetrate through the second outer peripheral wall 62 in a thickness direction. Each second engaging portion 80 is an engaging hole formed to penetrate through the second outer peripheral wall 62 in a radial direction of the second body portion 60. Each second engaging portion 80 is provided in an end part in the first opposite direction X2 of the second outer peripheral wall 62. Each second engaging portion 80 is formed to expose a part of the third end surface 63 of the back wall 61. Each second engaging portion 80 extends along the circumferential direction of the second body portion 60.

As shown in FIG. 1, each second engaging portion 80 is engaged with each first engaging portion 40. Each second engaging portion 80 has a second engaging surface 81 engageable with the first engaging surface 43 of each first engaging portion 40. The second engaging surface 81 is an end surface facing in the first opposite direction X2, out of the second engaging portion 80. Each second engaging surface 81 is engaged with the first engaging surface 43 of each first engaging portion 40 along the first axis X. Each second engaging portion 80 and each first engaging portion 40 are engaged with each other by snap fitting utilizing the deflection and deformation of the deflection piece 41 of the first engaging portion 40. The first and second housings 11, 50 are maintained in a united state by the engagement of each second engaging portion 80 and each first engaging portion 40. Note that an engaged part of each second engaging portion 80 and each first engaging portion 40 is provided in the external space of the device case 200 when the first housing 11 is fit into the mounting hole 210.

With the first and second housings 11, 50 assembled, the third end surface 63 of the back wall 61 is in contact with the second end surface 22 of the first body portion 20 and in contact with an end surface in the first opposite direction X2 of the potting material 100.

### (Configuration of First Sealing Member 110)

The first sealing member 110 is accommodated in the accommodation recess 24 of the first body portion 20. The first sealing member 110 is formed to surround the eight terminals 90 in a plan view from the first direction X1. The first sealing member 110 of this embodiment is formed into a circular ring shape. The first sealing member 110 is continuously formed over the entire periphery in the circumferential direction of the first body portion 20. The first sealing member 110 is, for example, made of rubber.

As shown in FIG. 1, the first sealing member 110 is provided between the first and second housings 11, 50 while being compressed in the first direction X1. The first sealing member 110 is provided between the bottom surface of the accommodation recess 24 and the third end surface 63 while being compressed in the first direction X1. The first sealing member 110 is held in close contact with the bottom surface of the accommodation recess 24 over the entire periphery in the circumferential direction and held in close contact with the third end surface 63 of the back wall 61 over the entire periphery in the circumferential direction. The first sealing member 110 seals between the end surface in the first direction X1 of the first housing 11 and the end surface in the first opposite direction X2 of the second housing 50. Specifically, the first sealing member 110 is compressed between the first and second housings 11, 50 and liquid-tight sealing is provided between the first and second housings 11, 50 by a surface seal. At this time, since the first sealing member 110 is pressed in the first direction X1 by the third end surface 63 of the back wall 61 formed into the flat surface parallel to the YZ plane, a surface pressure can be evenly applied to the first sealing member 110. In this way, a water stopping property can be improved.

### (Manufacturing Method of Relay Connector 10)

Next, a manufacturing method of the relay connector 10 is described.

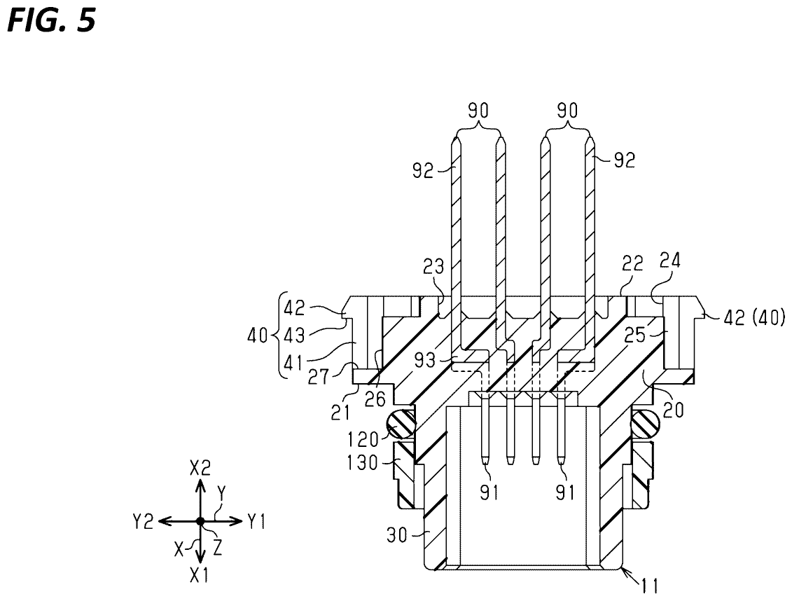

First, in a first step shown in FIG. 5, a structure is formed in which the plurality of terminals 90 each including the first terminal portion 91, the second terminal portion 92 and the coupling portion 93 and the first housing 11 including the first body portion 20, the first connector fitting portion 30 and the first engaging portions 40 are integrated. This structure can be formed by insert molding with the plurality of terminals 90 as insert components. At this time, the coupling portions 93 of the terminals 90 are embedded in the first body portion 20. Note that the first body portion 20 includes the recesses 23 and the accommodation recess 24 surrounding the recesses 23.

Subsequently, the second sealing member 120 is mounted on the outer periphery of the first connector fitting portion 30. Then, the retainer 130 is mounted on the outer periphery of the first connector fitting portion 30. By the retainer 130, a movement in the first direction X1 of the second sealing member 120 is restricted and the detachment of the second sealing member 120 from the first connector fitting portion 30 is suppressed.

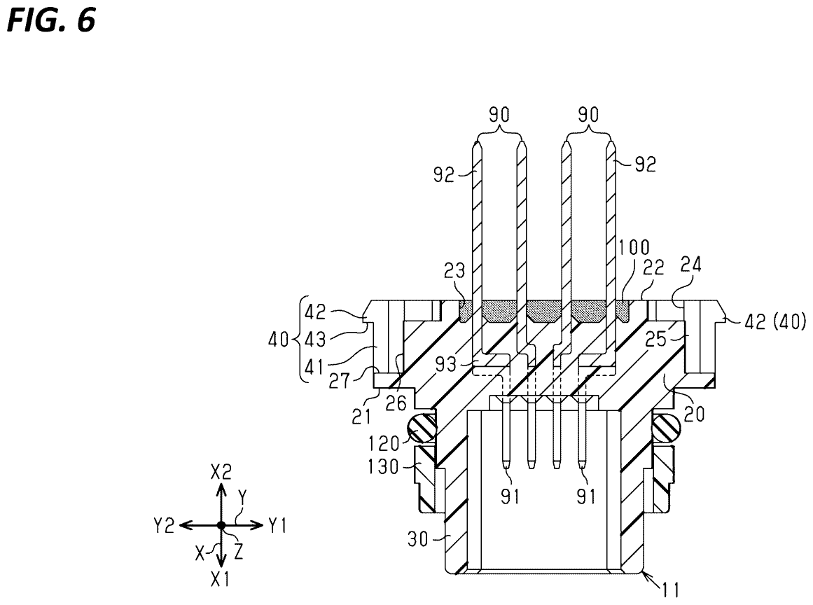

Subsequently, in a second step shown in FIG. 6, the potting material 100 is filled into the recesses 23 of the first body portion 20. The potting material 100 can be injected into the recesses 23, for example, using a dispenser or the like. At this time, a nozzle of the dispenser can be shortened and the operability of an injecting operation of the potting material 100 can be improved since the second housing 50 (see FIG. 1) is not assembled with the first housing 11 yet. Note that the potting material 100 shrinks during curing. According to the curing/shrinkage of the potting material 100, the terminals 90 in parts sealed by the potting material 100, i.e. the second terminal portions 92, may be deformed. If the second terminal portions 92 are deformed, the pitches of the second terminal portions 92 vary and the tip positions of the second terminal portions 92 vary.

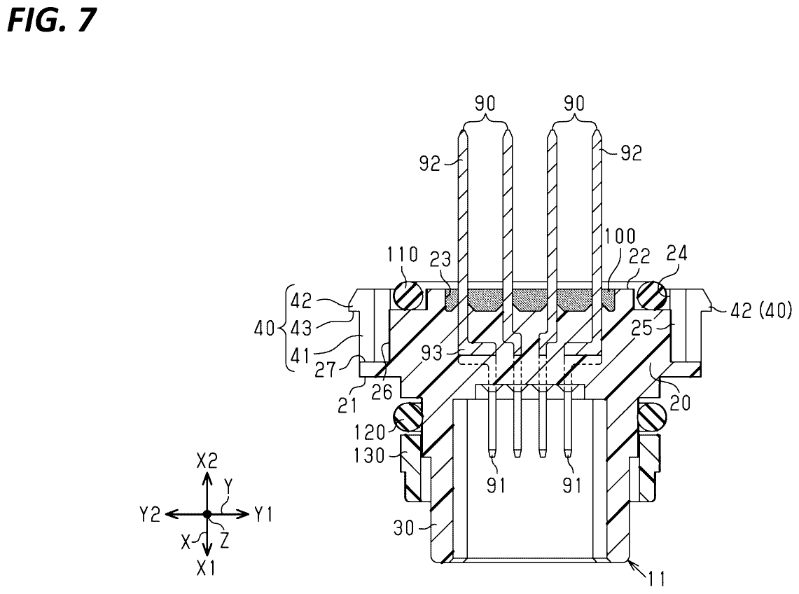

Subsequently, in a third step shown in FIG. 7, the first sealing member 110 is accommodated into the accommodation recess 24 of the first body portion 20. At this time, an end part in the first opposite direction X2 of the first sealing member 110 projects further in the first opposite direction X2 than the second end surface 22 of the first body portion 20.

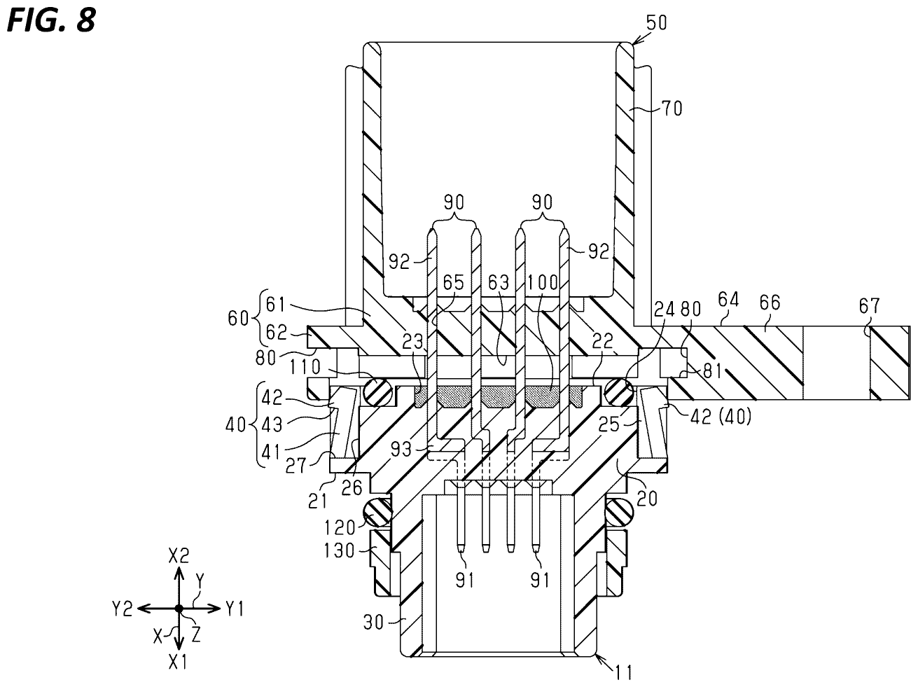

Subsequently, in a fourth step shown in FIG. 8, the second housing 50 including the second body portion 60, the second connector fitting portion 70 and the second engaging portions 80 is prepared. The second body portion 60 includes the back wall 61, the second outer peripheral wall 62 and the fixing portion 66. Then, the first and second housings 11, 50 are so arranged that the second end surface 22 of the first housing 11 and the third end surface 63 of the second housing 50 face each other.

Subsequently, the second housing 50 is assembled with the first housing 11 having the first sealing member 110 mounted therein. The second housing 50 is assembled with the first housing 11 along the first direction X1. In particular, the second housing 50 is brought relatively closer to the first housing 11 with the eight second terminal portions 92 and the eight insertion holes 65 respectively aligned. In this way, the eight second terminal portions 92 are respectively inserted into the corresponding eight insertion holes 65. For example, each second terminal portion 92 is press-fit into each insertion hole 65. If the respective second terminal portions 92 are inserted into the respective insertion holes 65 in this way, the deformation of the second terminal portions 92 can be corrected and the pitches of the second terminal portions 92 can be corrected in accordance with those of the insertion holes 65. If the second housing 50 is subsequently further assembled with the first housing 11, the second outer peripheral wall 62 of the second housing 50 contacts the engaging projections 42 of the first engaging portions 40. In this way, the deflection pieces 41 of the first engaging portions 40 are resiliently deformed to deflect radially inwardly. Thereafter, if the second engaging surfaces 81 ride over the engaging projections 42, the first engaging portions 40 are resiliently restored into an original shape. In this way, as shown in FIG. 1, the first engaging surfaces 43 of the first engaging portions 40 are engaged with the second engaging surfaces 81 of the second engaging portions 80. By such engagement of the first and second engaging surfaces 43, 81, the second housing 50 is fixed to the first housing 11 and the separation of the second housing 50 from the first housing 11 can be suppressed. At this time, the first sealing member 110 is provided between the first and second housings 11, 50 while being compressed in the first direction X1. Further, the third end surface 63 of the second body portion 60 of the second housing 50 is in contact with the second end surface 22 of the first body portion 20 of the first housing 11 and in contact with the end surface in the first opposite direction X2 of the potting material 100.

By the above manufacturing process, the relay connector 10 of this embodiment can be manufactured.

### Functions and Effects of Embodiment

Next, functions and effects of this embodiment are described.

(1) The relay connector 10 is provided with the plurality of electrically conductive terminals 90, the first housing 11 configured to hold the plurality of terminals 90 and including the recesses 23 and the second housing 50 to be assembled with the first housing 11 along the first direction X1. The relay connector 10 is provided with the potting material 100 formed in the recesses 23 and the first sealing member 110 provided between the first and second housings 11, 50 while being compressed in the first direction X1. The first housing 11 includes the first body portion 20 for holding the plurality of terminals 90 and the tubular first connector fitting portion 30 projecting in the first direction X1 from the first end surface 21 facing in the first direction X1, out of the first body portion 20. The first housing 11 includes the recesses 23 recessed in the first direction X1 from the second end surface 22 facing in the first opposite direction X2 opposite to the first direction X1, out of the first body portion 20, and the plurality of first engaging portions 40 engageable with the second housing 50. The second housing 50 includes the second body portion 60 having the plurality of insertion holes 65, through which the plurality of terminals 90 are individually passed, and the plurality of second engaging portions 80 respectively engageable with the plurality of first engaging portions 40. The first sealing member 110 is formed to surround the plurality of terminals 90. The first and second engaging portions 40, 80 are provided outside the first sealing member 110.

According to this configuration, the second housing 50 is assembled with the first housing 11 along the first direction X1. In other words, the first and second housings 11, 50 are constituted by separate components. Thus, the second housing 50 can be assembled with the first housing 11 after the potting material 100 is injected into the recesses 23 of the first housing 11, e.g. after the plurality of terminals 90 are deformed due to the shrinkage of the potting material 100. At this time, the second housing 50 includes the plurality of insertion holes 65, through which the plurality of terminals 90 are individually passed. By inserting the plurality of terminals 90 respectively into the plurality of these insertion holes 65, the deformation of the plurality of terminals 90 can be corrected and the pitches of the plurality of terminals 90 can be corrected based on those of the insertion holes 65. By assembling the second housing 50 with the first housing 11 after the potting material 100 is injected and cured in this way, the pitches of the plurality of terminals 90 can be corrected to be approximated to desired pitches. In this way, a reduction in connection reliability to the mating connector can be suitably suppressed.

(2) Further, in the relay connector 10, an assembled state (united state) of the first and second housings 11, 50 is maintained by the engagement of the first engaging portions 40 of the first housing 11 and the second engaging portions 80 of the second housing 50. However, in the assembled state, a gap may be formed between the first and second housings 11, 50. Liquid such as water may intrude into between the inner peripheral surfaces of the insertion holes 65 and the outer peripheral surfaces of the terminals 90 through such a gap. As a countermeasure against this, in the relay connector 10 of this embodiment, the first sealing member 110 surrounding the plurality of terminals 90 is provided inside the first and second engaging portions 40, 80. This first sealing member 110 is provided between the first and second housings 11, 50 while being compressed in the first direction X1. Sealing can be suitably provided between the first and second housings 11, 50 by such a first sealing member 110. In this way, the intrusion of the liquid into the space inside the first sealing member 110 can be suitably suppressed, for example, even if gaps are formed near engaged parts of the first and second engaging portions 40, 80. As a result, the intrusion of the liquid into between the inner peripheral surfaces of the insertion holes 65 and the outer peripheral surfaces of the terminals 90 can be suitably suppressed.

(3) The assembled state of the first and second housings 11, 50 is maintained by the engagement of the first and second engaging portions 40, 80. Thus, relative movements of the first and second housings 11, 50 are allowed in the assembled state as compared to the case where the first and second housings 11, 50 are integrated, such as by fusing. In this way, if vibration is, for example, applied to the second connector fitting portion 70, that vibration can be reduced by a relative movement of the second housing 50 with respect to the first housing 11 and the first sealing member 110. Therefore, if vibration is applied to the second connector fitting portion 70, the transmission of that vibration to the first housing 11 can be reduced.

(4) Each of the plurality of first engaging portions 40 includes the deflectable and deformable deflection piece 41 extending along the first direction X1, and the engaging projection 42 projecting in the intersecting direction intersecting the first direction X1 from the end part in the first opposite direction X2 of the deflection piece 41. According to this configuration, the engaging projection 42 of the first engaging portion 40 and the second engaging portion 80 can be suitably engaged by snap fitting utilizing the deflection and deformation of the deflection piece 41 of the first engaging portion 40. By the engagement of the engaging projections 42 of the first engaging portions 40 and the second engaging portions 80, the assembled state of the first and second housings 11, 50 can be suitably maintained.

(5) The first body portion 20 includes the accommodation recess 24 recessed in the first direction X1 from the second end surface 22 of the first body portion 20. The accommodation recess 24 is formed to surround the recesses 23. The first sealing member 110 is accommodated in the accommodation recess 24. According to this configuration, the first sealing member 110 is accommodated in the accommodation recess 24 recessed in the first direction X1 from the second end surface 22 facing the first opposite direction X2, out of the first body portion 20. Thus, a movement of the first sealing member 110 can be restricted by the inner wall surface of the accommodation recess 24. In this way, a position deviation of the first sealing member 110 in the direction orthogonal to the first direction X1 can be suitably suppressed.

(6) The first body portion 20 includes the first outer peripheral wall 25 surrounding the first sealing member 110 and the plurality of cut portions 26 formed by cutting the first outer peripheral wall 25. The plurality of first engaging portions 40 are respectively provided in the plurality of cut portions 26. According to this configuration, the first sealing member 110 is surrounded by the first outer peripheral wall 25. Thus, a movement of the first sealing member 110 can be restricted by the first outer peripheral wall 25. In this way, a position deviation of the first sealing member 110 can be suitably suppressed.

(7) The second body portion 60 includes the back wall 61 having the third end surface 63 facing the second end surface 22 of the first body portion 20 and the second outer peripheral wall 62 projecting in the first direction X1 from the back wall 61. The second outer peripheral wall 62 is formed to surround the first outer peripheral wall 25. The first sealing member 110 is held in close contact with the third end surface 63 of the back wall 61 and held in close contact with the bottom surface of the accommodation recess 24. Each of the plurality of second engaging portions 80 is an engaging hole formed to penetrate through the second outer peripheral wall 62 in the thickness direction.

According to this configuration, each second engaging portion 80 is formed to penetrate through the second outer peripheral wall 62 formed to surround the first outer peripheral wall 25. Each second engaging portion 80 is engaged with each first engaging portion 40 provided inside the cut portion 26 formed by cutting the first outer peripheral wall 25. Gaps are easily formed between the first and second housings 11, 50 near the engaged parts of these first and second engaging portions 40, 80. As a countermeasure against this, in the relay connector 10 of this embodiment, the first sealing member 110 is provided inside the first and second engaging portions 40, 80. Sealing can be suitably provided between the first and second housings 11, 50 by such a first sealing member 110. In this way, the intrusion of liquid into the space inside the first sealing member 110 can be suitably suppressed even if the gaps are formed near the engaged parts of the first and second engaging portions 40, 80.

(8) The first sealing member 110 is compressed between the third end surface 63 of the back wall 61 and the bottom surface of the accommodation recess 24. In this way, liquid-tight sealing can be provided between the third end surface 63 of the back wall 61 and the bottom surface of the accommodation recess 24 by the surface seal.

(9) The relay connector 10 is mounted into the mounting hole 210 of the device case 200 having the internal space, which is an oil environment, and the external space, which is an air environment. The second housing 50 includes the second connector fitting portion 70 projecting in the first opposite direction X2 from the fourth end surface 64 facing in the first opposite direction X2, out of the second body portion 60. The first connector fitting portion 30 is provided to project into the internal space of the device case 200. The second connector fitting portion 70 is provided to project into the external space of the device case 200. The engaged parts of the first and second engaging portions 40, 80 are provided in the external space of the device case 200.

According to this configuration, the engaged parts of the first and second engaging portions 40, 80 are provided in the external space of the device case 200, which is the air environment. Thus, it can be suitably suppressed that the engaged parts of the first and second engaging portions 40, 80, i.e. parts where gaps are easily formed between the first and second housings 11, 50, are exposed to the oil environment.

(10) The second body portion 60 includes the fixing portion 66 extending along the second direction Y1 intersecting the first direction X1 and configured to fix the relay connector 10 to the device case 200. The fixing portion 66 includes the bolt hole 67. The second body portion 60 is integrally formed with the second connector fitting portion 70. According to this configuration, the relay connector 10 can be fixed to the device case 200 by tightening the bolt inserted into the bolt hole 67 of the fixing portion 66. Further, the second body portion 60 including the fixing portion 66 for fixing the relay connector 10 to the device case 200 can be integrally formed with the second connector fitting portion 70. In this way, the number of components of the relay connector 10 can be reduced as compared to the case where the second body portion 60 including the fixing portion 66 and the second connector fitting portion 70 are constituted by separate components.

(11) The relay connector includes the second sealing member 120 mounted on the outer periphery of the first connector fitting portion 30 and the retainer 130 mounted on the outer periphery of the first connector fitting portion 30. The retainer 130 is engageable with the second sealing member 120 and restricts a movement in the first direction X1 of the second sealing member 120. According to this configuration, a movement in the first direction X1 of the second sealing member 120 mounted on the outer periphery of the first connector fitting portion 30 is restricted by the retainer 130 mounted on the outer periphery of the first connector fitting portion 30. In this way, the detachment of the second sealing member 120 from the first connector fitting portion 30 can be suitably suppressed.

### Other Embodiments

The above embodiment can be modified and carried out as follows. The above embodiment and the following modifications can be carried out in combination without technically contradicting each other.
Although the engaging projection 42 of the first engaging portion 40 and the second engaging portion 80, which is an engaging hole, are engaged with each other in the above embodiment, the engagement form of the first and second engaging portions 40, 80 is not limited to this. For example, the second engaging portion 80 may be formed into a structure including an engaging projection to be engaged with the engaging projection 42. Further, the first engaging portion 40 may be formed into an engaging hole and the second engaging portion 80 may be formed into a structure including a deflection piece and an engaging projection.
The number of the first engaging portions 40 in the above embodiment is not particularly limited.
The number of the second engaging portions 80 in the above embodiment is not particularly limited.
The structure of the first housing 11 of the above embodiment can be changed as appropriate.
Although the two recesses 23 are provided in the second end surface 22 of the first body portion 20 in the above embodiment, there is no limitation to this. For example, one recess 23 for collectively surrounding the eight terminals 90 may be provided in the second end surface 22 of the first body portion 20.
The accommodation recess 24 in the above embodiment may be omitted. The first sealing member 110 in this case is, for example, provided on the second end surface 22 of the first body portion 20.
The structure of the second housing 50 of the above embodiment can be changed as appropriate.
Although the second housing 50 is embodied as a single component integrally formed with the second body portion 60 and the second connector fitting portion 70 in the above embodiment, there is no limitation to this. For example, the second body portion 60 and the second connector fitting portion 70 may be constituted by separate components.
Although the second housing 50 is formed into the structure including the fixing portion 66 in the above embodiment, there is no limitation to this. For example, the first housing 11 may be provided with the fixing portion 66.
The structure of each terminal 90 in the above embodiment can be changed as appropriate. For example, the coupling portion 93 may be changed into a structure including no bent part. In this case, the first terminal portion 91, the coupling portion 93 and the second terminal portion 92 are formed to extend on a straight line.
The number of the terminals 90 in the above embodiment is not particularly limited.
Although the second sealing member 120 is mounted on the outer periphery of the first connector fitting portion 30 in the above embodiment, there is no limitation to this. For example, the second sealing member 120 may be mounted on the outer periphery of the first body portion 20.
In the above embodiment, a fitting groove portion, into which the second sealing member 120 is fit, may be formed in the outer peripheral surface of the first connector fitting portion 30. In this case, the retainer 130 can be omitted.
Although the relay connector 10 to be mounted on the device case 200, which is a transmission case, is embodied in the above embodiment, there is no limitation to this. For example, the present disclosure may be applied to a relay connector to be used for a device case other than the transmission case. Note that the environment inside the device case 200, on which the relay connector 10 is mounted, is not limited to the oil environment, and application to a relay connector of a device, in which oil is not used inside the device case 200, is also possible.
The embodiment disclosed this time should be considered illustrative in all aspects, rather than restrictive. The scope of the present invention is represented not by the above meaning, but by claims and is intended to include all changes in the scope of claims and in the meaning and scope of equivalents.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A relay connector, comprising:
a plurality of electrically conductive terminals;
a first housing for holding the plurality of terminals, the first housing including a recess,
a second housing to be assembled with the first housing along a first direction;
a potting material injected into the recess; and
a first sealing member provided between the first and second housings while being compressed in the first direction,
the first housing including:
a first body portion for holding the plurality of terminals;
a tubular first connector fitting portion projecting in the first direction from a first end surface facing in the first direction, out of the first body portion;
the recess recessed in the first direction from a second end surface facing in a first opposite direction opposite to the first direction, out of the first body portion; and
a first engaging portion engageable with the second housing, and
the second housing including:
a second body portion including a plurality of insertion holes, the plurality of terminals being individually passed through the plurality of insertion holes; and
a second engaging portion engageable with the first engaging portion, the first sealing member being formed to surround the plurality of terminals, and each of the first and second engaging portions being provided outside the first sealing member.

2. The relay connector of claim 1, wherein the first engaging portion includes a deflectable and deformable deflection piece extending along the first direction and an engaging projection projecting in an intersecting direction intersecting the first direction from an end part in the first opposite direction of the deflection piece.

3. The relay connector of claim 1, wherein:
the first body portion includes an accommodation recess recessed in the first direction from the second end surface of the first body portion,
the accommodation recess is formed to surround the recess, and
the first sealing member is accommodated in the accommodation recess.

4. The relay connector of claim 3, wherein:
the first body portion includes a first outer peripheral wall for surrounding the first sealing member and a cut portion formed by cutting the first outer peripheral wall, and
the first engaging portion is provided in the cut portion.

5. The relay connector of claim 4, wherein:
the second body portion includes a back wall having a third end surface facing the second end surface of the first body portion and a second outer peripheral wall projecting in the first direction from the back wall,
the second outer peripheral wall is formed to surround the first outer peripheral wall,
the first sealing member is held in close contact with the third end surface of the back wall and held in close contact with a bottom surface of the accommodation recess, and
the second engaging portion is an engaging hole formed to penetrate through the second outer peripheral wall in a thickness direction.

6. The relay connector of claim 1, wherein:
the relay connector is mounted into a mounting hole of a device case having an internal space and an external space, the internal space being an oil environment, the external space being an air environment,
the second housing includes a second connector fitting portion projecting in the first opposite direction from a fourth end surface facing in the first opposite direction, out of the second body portion,
the first connector fitting portion is provided to project into the internal space of the device case,
the second connector fitting portion is provided to project into the external space of the device case, and
an engaged part of the first and second engaging portions is provided in the external space of the device case.

7. The relay connector of claim 6, wherein:
the second body portion includes a fixing portion extending along a second direction intersecting the first direction, the fixing portion fixing the relay connector to the device case,
the fixing portion includes a bolt hole, and
the second body portion is integrally formed with the second connector fitting portion.

8. The relay connector of claim 1, comprising:
a second sealing member mounted on an outer periphery of the first connector fitting portion; and
a retainer mounted on the outer periphery of the first connector fitting portion,
wherein the retainer is engageable with the second sealing member and restricts a movement of the second sealing member in the first direction.
